(19) United States
(12) Patent Application Publication
(10) Pub. No.: US 2025/0206182 A1
(43) Pub. Date: Jun. 26, 2025

(54) V2B CHARGE/DISCHARGE SCHEDULING DEVICE AND V2B CHARGE/DISCHARGE SCHEDULING METHOD

(71) Applicants: Hyundai Motor Company, Seoul (KR); Kia Corporation, Seoul (KR)

(72) Inventors: Dae Gun Ko, Hwaseong-si (KR); Hyun Sup Kim, Gwangmyeong-si (KR); Kyoung Joo Kim, Daejeon (KR); Min Kyu Lee, Seoul (KR); Jeong Hoon Choi, Hwaseong-si (KR); Bum Su Park, Hwaseong-si (KR); Hye Seung Han, Hwaseong-si (KR); Sung Kyu Kim, Bucheon-si (KR); Jae Yun Jung, Hwaseong-si (KR)

(21) Appl. No.: 18/776,523

(22) Filed: Jul. 18, 2024

(30) Foreign Application Priority Data
Dec. 20, 2023 (KR) 10-2023-0187621

(51) Int. Cl. B60L 55/00; B60L 53/62; B60L 53/63; B60L 53/64; B60L 53/66; B60L 53/67

(52) U.S. Cl. CPC B60L 55/00; B60L 53/62; B60L 53/63; B60L 53/64; B60L 53/665; B60L 53/67

(57) ABSTRACT

A vehicle to building (V2B) charge/discharge scheduling method can include inputting input data including at least one of electric vehicle information related to battery charging and discharging of electric vehicles, building information related to power use of a building, and electric vehicle supply equipment (EVSE) information related to EVSEs connected to the electric vehicles and charging and discharging a battery; setting a scheduling model using the input data and an objective function; outputting optimization data using the scheduling model; and performing charge/discharge scheduling of the electric vehicles using the optimization data, wherein the setting a scheduling model includes setting the scheduling model using mixed-integer linear programming (MILP) if a number of electric vehicles is not greater than a number of EVSEs; and setting the scheduling model using mixed-integer quadratic programming (MIQP) if the number of electric vehicles is greater than the number of EVSEs.

### CROSS-REFERENCE TO RELATED APPLICATIONS

This application claims benefit of priority to Korean Patent Application No. 10-2023-0187621 filed on Dec. 20, 2023 in the Korean Intellectual Property Office, the disclosure of which is incorporated herein by reference in its entirety.

### TECHNICAL FIELD

The present disclosure relates to an electric vehicle charge/discharge scheduling device and method.

### BACKGROUND

Recently, as electric vehicle (EV) related technology has advanced, technology that may externally use power of a battery mounted on an electric vehicle (V2L: vehicle to load) has been provided as a service. Using this V2L technology, power may be supplied externally without additional equipment through an integrated charging system and a vehicle charging management system.

Furthermore, vehicle to grid (V2G) technology, which stores residual power of a battery and uses the power when needed, is soon to be commercialized. Renewable energies such as solar and wind power are considered to be clean energy, but such energies have a limitation of unstable production due to many external factors such as weather. To address such limitations, an energy storage system (ESS) may be necessary, but an ESS may be expensive, may have limitations in installation, and may need to be fixed, which may be disadvantageous.

Accordingly, V2G technology, used as a storage device for renewable energy using an idle time of a battery of an electric vehicle, has drawn attention. V2G technology may address the issues in stabilizing supply and demand in a power grid by using a battery of an electric vehicle, and the technology may include vehicle to home (V2H), vehicle to building (V2B), and vehicle to grid (V2G) techniques, depending on where electricity is used.

### SUMMARY

The present disclosure relates to an electric vehicle charge/discharge scheduling device and an electric vehicle charge/discharge scheduling method applicable to V2B technology.

An embodiment of the present disclosure can perform optimal charge/discharge scheduling by setting an appropriate scheduling model depending on the number of electric vehicles and charging stations.

The purpose of the present disclosure is not limited thereto, and a person having ordinary skill in the art can understand that other technical issues not mentioned can be derived from the configurations in the specification and drawings.

Some embodiments of the present disclosure can provide a V2B charge/discharge scheduling method and V2B charge/discharge scheduling device.

According to an embodiment of the present disclosure, a vehicle to building (V2B) charge/discharge scheduling method can include: inputting input data including at least one of electric vehicle information related to battery charging and discharging of electric vehicles, building information related to power use of a building, and electric vehicle supply equipment (EVSE) information related to EVSEs connected to the electric vehicles and charging and discharging a battery; setting a scheduling model using the input data and an objective function; outputting optimization data using the scheduling model; and performing charge/discharge scheduling of the electric vehicles using the optimization data, where the setting a scheduling model includes setting the scheduling model using mixed-integer linear programming (MILP) when the number of electric vehicles is not greater than the number of EVSEs; and setting the scheduling model using mixed-integer quadratic programming (MIQP) when the number of electric vehicles is greater than the number of EVSEs.

According to an embodiment of the present disclosure, a vehicle to building (V2B) charge/discharge scheduling device can include a processor and a storage medium in which commands for executing one or more programs configured to be executable by the processor, where the one or more programs can include: inputting input data including at least one of electric vehicle information related to battery charging and discharging of electric vehicles, building information related to power use of a building, and electric vehicle supply equipment (EVSE) information related to EVSEs connected to the electric vehicles and charging and discharging a battery; setting a scheduling model using the input data and an objective function; outputting optimization data using the scheduling model; and performing charge/discharge scheduling of the electric vehicles using the optimization data, where the setting a scheduling model includes setting the scheduling model using mixed-integer linear programming (MILP) when the number of electric vehicles is not greater than the number of EVSEs; and setting the scheduling model using mixed-integer quadratic programming (MIQP) when the number of electric vehicles is greater than the number of EVSEs.

### BRIEF DESCRIPTION OF THE DRAWINGS

The above and other embodiments, features, and advantages of the present disclosure can be more clearly understood from the following detailed description, taken in conjunction with the accompanying drawings, in which:

FIG. 1 is a diagram illustrating a V2B charge/discharge scheduling system according to an embodiment of the present disclosure;

FIG. 2 is a flowchart illustrating a V2B charge/discharge scheduling method according to an embodiment of the present disclosure;

FIG. 3 is a flowchart illustrating a scheduling model setting method depending on the number of electric vehicles and the number of charging stations according to an embodiment of the present disclosure;

FIG. 4 is a diagram illustrating a scheduling model setting method according to a mixed integer linear programming method according to an embodiment of the present disclosure;

FIG. 5 is a diagram illustrating a scheduling model setting method according to a mixed integer quadratic programming method according to an embodiment of the present disclosure;

FIG. 6 is a block diagram illustrating a computing device which may fully or partially implement a V2B charge/discharge scheduling device according to an embodiment of the present disclosure;

FIG. 7 is a graph indicating a profit effect according to an embodiment of the present disclosure; and

FIG. 8 is a table listing a profit effect according to an embodiment of the present disclosure.

### DETAILED DESCRIPTION OF ILLUSTRATIVE EMBODIMENTS

Hereinafter, some example embodiments of the present disclosure will be described with reference to the attached drawings. However, redundant descriptions and detailed descriptions of known functions and elements that may unnecessarily make the gist of the present invention obscure can be omitted. In the drawings, components having similar functions and application can be indicated by same reference numerals.

In the present disclosure, the term “connected” may not only refer to “directly connected” but also include “indirectly connected”. Also, the term “electrically connected” may include both of the case in which elements are “physically connected” and the case in which elements are “not physically connected” (e.g., wireless). The terms, “include,” “comprise,” “is configured to,” or the like, of the present disclosure are used to indicate the presence of features, numbers, steps, operations, elements, portions, or combination thereof, and do not exclude the possibilities of combination or addition of one or more features, numbers, steps, operations, elements, portions, or combination thereof.

The present disclosure is not limited to example embodiments, and it can be understood that various modifications may be made without departing from the spirit and scopes of the present disclosure.

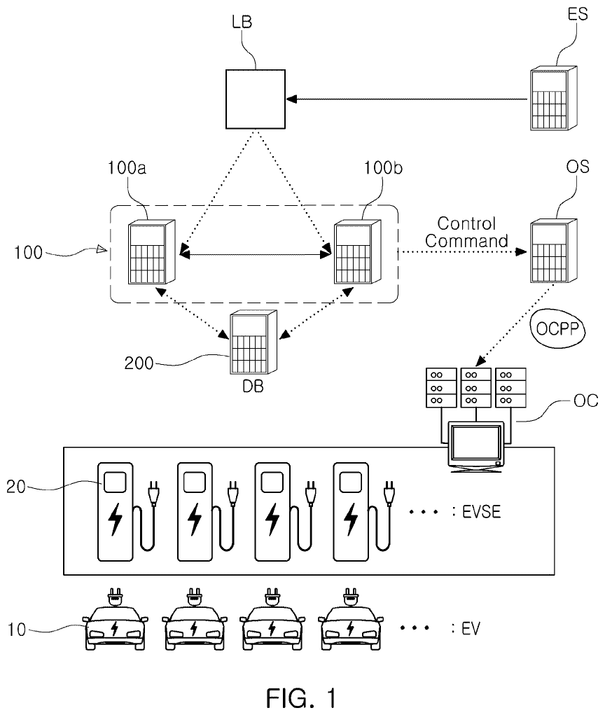

FIG. 1 is a diagram illustrating a V2B charge/discharge scheduling system according to an embodiment of the present disclosure.

Referring to FIG. 1, the V2B charge/discharge scheduling device 100 according to an embodiment may be implemented as a server to which the V2B algorithm is applied and may include a master server 100a and a slave server 100b. The master server 100a or the slave server 100b may be used to back up the other server when one of the servers is unavailable. Also, the V2B charge/discharge scheduling device 100 may be configured to read or write data by transmitting signals to and receiving signals from the DB server 200. The DB server 200 may store data needed to apply a V2B algorithm. For example, the DB server 200 may store a state of charge (SoC) of a battery, and an entry/exit plan of the EV.

An external link server (ES) may receive a control signal from an application/app by a user and may transfer the signal to a load balancer (LB). The load balancer (LB) may be between a client and a server group, and may distribute traffic applied to the server to multiple servers.

The open charge point protocol (OCPP) server (OS) may provide a protocol applied with industry standards developed for the purpose of operation and maintenance of EVSE, and the OCPP client (OC) may receive commands from the OCPP server (OS) and may control EVSE or charging and discharging of the EVSE 20.

An embodiment of the present disclosure may be applied to V2B technology applied to an electric vehicle (EV) 10 that may perform bidirectional charging/discharging, electric vehicle supply equipment (EVSE) 20 that is plugged in to the electric vehicle 10 and perform charging and discharging, and a building in which the EVSE 20 is installed.

An embodiment of the present disclosure can suggest a profit optimization modeling depending on the number of electric vehicles 10 and the number of EVSEs 20 that may perform bidirectional charging/discharging using V2B technology for supplying power of the electric vehicle to a building.

In this example case, a profit of V2B may include an arbitrage profit obtained from charging when an electricity usage price is low and discharging when an electricity usage price is high, a smart-charging profit obtained from charging at the time of the day when an electricity usage fee is the lowest, and a profit obtained by maintaining or lowering a basic rate depending on contract power by suppressing the effect of increasing the basic rate of a building by discharging into the building when a maximum load of the building is predicted to be exceeded.

The V2B charge/discharge scheduling device according to an embodiment may be implemented by a V2X platform providing a V2X service. The V2X platform may directly manage electric vehicles, EVSE of customers participating in the V2X service, and may perform charge/discharge scheduling of electric vehicles to derive an optimal fee for a user group through optimization software.

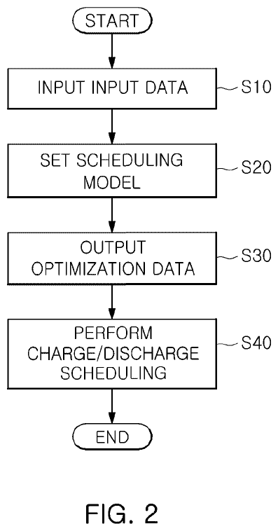

FIG. 2 is a flowchart illustrating a V2B charge/discharge scheduling method according to an embodiment of the present disclosure.

Referring to FIG. 2, the V2B charge/discharge scheduling method according to an embodiment may include an operation S10 of inputting input data, an operation S20 of setting a scheduling model, and an operation S30 of outputting optimization data using a scheduling model, and an operation S40 of performing charge/discharge scheduling of an electric vehicles using optimization data.

In S10 operation, the input data may include at least one of electric vehicle information related to battery charging and discharging of electric vehicles, building information related to power use of a building, and electric vehicle supply equipment (EVSE) information related to EVSEs connected to the electric vehicles and charging and discharging a battery thereof.

More specifically, electric vehicle information may include an entry/exit plan or a scheduling plan (D+2 days) of each of the electric vehicles, a state of charge of a battery at entry, a target state of charge at exit, a predetermined battery charging range, and a battery charge/discharge specification. The entry/exit plan may refer to entry and exit from a building and may indicate the predetermined estimated time of planned entry and exit of an electric vehicle. The state of charge of a battery at entry may indicate a state of charge (SoC) of a battery when the electric vehicle enters, and the target state of charge at exit may be a target state of charge which may need to be reached at the estimated exit time of the electric vehicle, and may be determined in advance by a user. The predetermined battery charging range may be determined from 0% to 100%, or may be a predetermined range by a user. The battery charge/discharge specification may be information such as charging capacity of the electric vehicle.

The building information may include a time-of-use price (TOUP) of electricity of a building, contract power of a building, and estimated load of a building. The time-of-use price of electricity of a building may include electricity rate information according to the amount of electricity used, which can be set differently for each time slot, the contract power of a building may indicate maximum power a building contracted to use, and a basic fee may be maintained when used within the contract power, but when used in excess of the contract power, the basic fee may increase. Accordingly, buildings may reduce fees by maintaining power usage within the contract power. Also, the estimated load of a building may indicate the amount of electricity estimated to be used by the building by time of day of season.

The EVSE information may include plug-in/out information related to whether each EVSE is connected to an electric vehicle. The EVSE information may include an ID of each EVSE and plug-in/out information indicating whether the EVSE is connected to an electric vehicle.

In S20 operation, the scheduling model may be determined using input data and an objective function.

In this example case, the scheduling model may be set within constraints. The constraints may include a condition in which an electric vehicle may only perform one of plans of charging or discharging per time slot, a condition in which an electric vehicle performs charging/discharging based on charging and discharging specifications, a condition in which an electric vehicle performs charging/discharging within an allowable range of a battery, and a condition in which an electric vehicle only creates plans when plugged into an EVSE. The charge and discharge specifications may indicate a maximum charge or discharge, and the battery allowable range may indicate a range of 0% to 100%.

The optimization data may be output using the scheduling model determined in S30 operation, and the charge/discharge scheduling of electric vehicles may be performed using the optimization data in S40 operation. In this example case, the optimization data may indicate each electric vehicle charging and discharging optimization plan created through optimization of the determined scheduling model. The optimization data may have one of charging, discharging, building peak discharging, standby, and error plans of the electric vehicle.

The scheduling model setting operation may apply different modeling methods depending on the number of electric vehicles and the number of EVSEs.

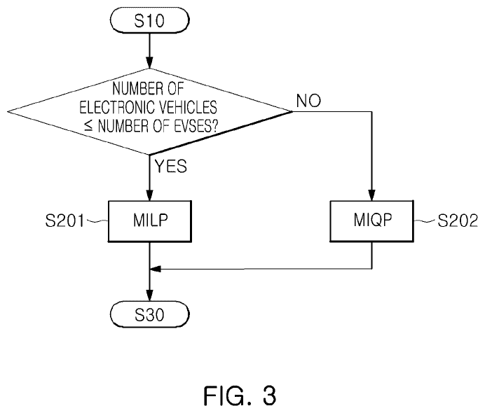

FIG. 3 is a flowchart illustrating a scheduling model setting method depending on the number of electric vehicles and the number of charging stations according to an embodiment of the present disclosure.

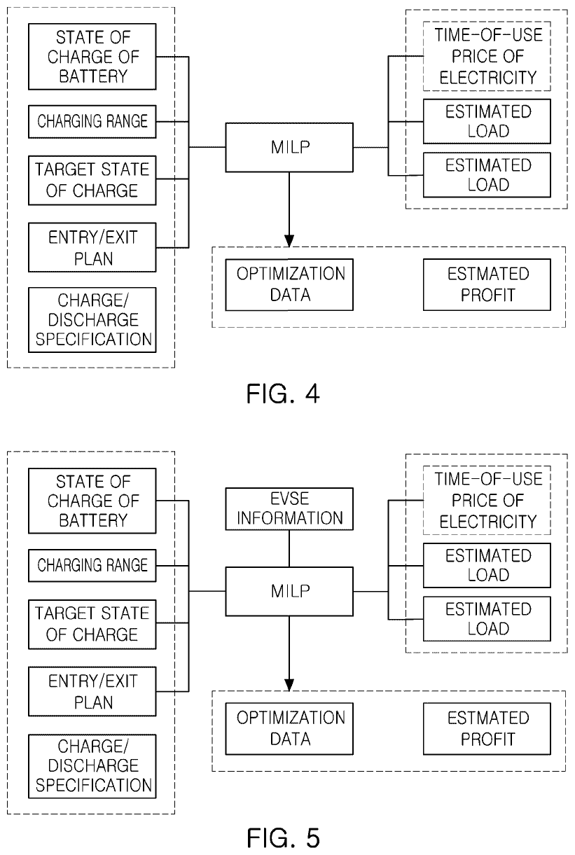

FIG. 4 is a diagram illustrating a scheduling model setting method according to a mixed integer linear programming method according to an embodiment of the present disclosure.

FIG. 5 is a diagram illustrating a scheduling model setting method according to a mixed integer quadratic programming method according to an embodiment of the present disclosure.

When the number of electric vehicles is equal to or less than the number of EVSEs, that is, when the number of electric vehicles is not greater than the number of EVSEs, it may not be necessary to consider the charging schedule of the electric vehicle, which indicates which electric vehicle among electric vehicles should be charged and which electric vehicle should be on standby. This is because the number of EVSEs is sufficient, such that the entirety of electric vehicles may be charged by plugging in to the EVSE.

When the number of electric vehicles is greater than the number of EVSEs, the entirety of electric vehicles may not be able to be plugged in to the EVSE, and accordingly, it may be necessary to consider which electric vehicle to plug in and at what point. Also, when the plug-in/out between the electric vehicle and the EVSE are frequently changed, scheduling complexity may increase and practical use may be difficult. Accordingly, it may be necessary to set the scheduling model in different ways depending on the number of electric vehicles and the number of EVSEs.

Referring to FIG. 4 along with FIG. 3, in operation S201, when the number of electric vehicles is not greater than the number of EVSEs, a scheduling model may be determined using mixed-integer linear programming (MILP). In this example case, the input data may include the electric vehicle information and the building information, and may not include the EVSE information.

When the number of electric vehicles is not greater than the number of EVSEs, the objective function may be configured as a linear objective function having a linear term according to Equations 1 to 3.

$${Objective}_{MILP} = ( {Cost}_{V 2 B} + {Slack}_{peak} ) \qquad [ Equation 1 ]$$

$${Cost}_{V 2 B} = {\sum }_{t} ( ( {EV}_{ChargeFee} {EV}_{DischargeFee} - {EV}_{PeakRevenue} * {WGT}_{peak} ) * {TOUP}_{t} \qquad [ Equation 2 ]$$

$${Slack}_{peak} = {\sum }_{t} ( ( {EV}_{ChargeCapa} + 1 ) * {Peak}_{AdjParam} * {TOUP}_{t} ) \qquad [ Equation 3 ]$$

An objective function may be for optimization of a learning a model with a certain purpose. An optimal solution may be obtained by finding a value minimizing the objective function or a cost function.

According to Equation 1, the linear objective function may be represented as a definition function minimizing the sum of the Cost_{V2B} function and the Slackₚₑₐₖ function.

According to Equation 2, the Cost_{V2B} function may be a variable related to an actual fee and may include discharge profit weight of when a charging fee of the electric vehicle minus discharge profit minus contract power of a building is exceeded. When the contract power of a building is exceeded, an objective function may be determined to not exceed the contract power of a building by adding a penalty to enable rapid discharge. Also, EV_{chargefee} may be the fee consumed when the EV is charged, and may be roughly represented as [charge state x charging fee (usage fee for corresponding time)]. EV_{dischargefee} may be the fee for EV discharging to a building, and may be represented as discharge amount times usage fee for corresponding time. Also, EVₚₑₐₖᵣₑᵥₑₙᵤₑ may have the same value as EV_{chargefee}, but may be multiplied by a peak weight to induce EV electricity to be discharged to the building when a peak occurs.

Slackₚₑₐₖ function may be an auxiliary variable to prevent the power consumption of a building from exceeding target power due to charging of an electric vehicle. When constraints are determined not to exceed the contract power of a building, there may be cases in which an optimal solution is not able to be obtained using the objective function, and the function may help find a solution even when the contract power of a building is exceeded. In the Slackₚₑₐₖ function, Peak_{AdjParam} may start to increase when the electricity usage of the building exceeds the target power, and the EV charging capacity from a point when the target power of the building is exceeded may act as a penalty.

When the number of electric vehicles is not greater than the number of EVSEs, a scheduling model using MILP may be determined using input data, constraints, and linear objective function, optimization data may be output, and estimated profit or estimated fee may be calculated.

Referring to FIG. 5 together with FIG. 3, in operation S202, when the number of electric vehicles is greater than the number of EVSEs, a scheduling model may be determined using mixed-integer quadratic programming (MIQP). In this example case, the input data may include electric vehicle information, building information, and EVSE information.

When the number of electric vehicles is greater than the number of EVSEs, the objective function may be configured as an objective function having a quadratic term according to Equation 4.

$${Objective}_{MIQP} = ( {Cost}_{V 2 B} + {Slack}_{peak} + {EV}_{SoC} - {EVSE}_{plugin} * {Plug WGT}_{evse} ) \qquad [ Equation 4 ]$$

$${EV}_{SoC} = {\sum }_{t} ( ( {SoC\_Upper}_{AdjParam} * {SoC\_Upper}_{AdjParam} + {SoC\_Lower}_{AdjParam} - {SoC\_Lower}_{AdjParam} ) \qquad [ Equation 5 ]$$

$${EVSE}_{plugin} = {\sum }_{t - 1} ( ( {EVSE}_{plug t} + {EVSE}_{plug t + 1} ) * ( {EVSE}_{plug t} + {EVSE}_{plug t + 1} ) ) \qquad [ Equation 6 ]$$

According to Equation 4, the objective function having a quadratic term may include a Cost_{V2B} function and a Slackₚₑₐₖ function according to Equation 2 and Equation 3, and may further include an EV_{soc} function and an EVSE_{plugin} function.

According to Equation 5, the EV_{soc} function may be a penalty added to satisfy a predetermined upper limit charge state or a predetermined lower limit charge state of a battery of the electric vehicle. When the predetermined upper limit charge state is exceeded or the predetermined lower limit charge state is not satisfied, a value may be generated in the EV_{soc} function and may act as a penalty.

According to Equation 6, the EVSE_{plugin} function may be a function aimed to maintain the plug-in state in which the charging device and the electric vehicle are connected to each other. For example, the EVSEplugt may have a value of one when plugged in at time t, and may be zero when plugged out. EVSE_{plugt+1} may have a value of one when plugged in at time t+1, and may have zero when plugged out. Because the function has a negative value, the function may be optimized to have a maximum value. Accordingly, an optimal solution may be obtained to maintain a charging device and the electric vehicle to be in a plug-in state using the EVSE_{plugin} function.

When the number of electric vehicles is greater than the number of EVSEs, a scheduling model using MIQP may be determined using an objective function having input data, constraints, and quadratic terms, optimization data may be output, and estimated profit or estimated fee may be calculated.

According to an embodiment, creation of an optimal control schedule for each electric vehicle may determine connectivity or maintaining of a plug-in state of the electric vehicle and the EVSE as the highest priority in addition to satisfying a target SoC upon exit to ensure mobility of the electric vehicle.

The optimization data according to an embodiment may be a scheduling plan data to be performed on D-Day and D+1 days subsequently, and the corresponding command may be transmitted to a charge point operate system (CPOS) using an open charge point protocol (OCPP) to control the EVSE and the electric vehicle.

The estimation of building power usage (load) for the V2B optimization model may generate an estimated value for subsequent 48 hours in 1-hour unit based on the current time. As an example, the V2B load estimation model suggested in the present disclosure used actual building power usage data from January 2022 to December 2022 and weather data from the Korea Meteorological Administration in the region in which the building is located, and used 8,760 samples per hour.

Also, as an example in the present disclosure, a 48-hour estimation was performed using four individual estimation models (SARIMAX, Random-Forest, XGBoost, and CatBoost), and the final result was corrected through a multi-layer perceptron (MLP) in an error-correction module of an estimated value of each estimation model.

The SARIMAX model may be a representative estimation model for time series that considers external variables in the ARIMA model used to analyze time series data considering external variables in an ARIMA model used to analyze time series data with trends and seasonality. The Random-Forest model may be an ensemble model combining multiple decision trees in parallel, and each tree may learn independently using randomly selected data and features, and the estimation results may be determined through voting.

XGBoost and CatBoost may be models corresponding to ensemble boosting, and may sequentially learn multiple decision trees in the direction of minimizing estimation errors. The four estimation models may predict load values by accepting a past building load value and weather and day of the week information as an input, and the estimated values of the models may be accepted as input values by a multi-layer perceptron including four layers, may perform error correction, and may calculate a final building load estimated value.

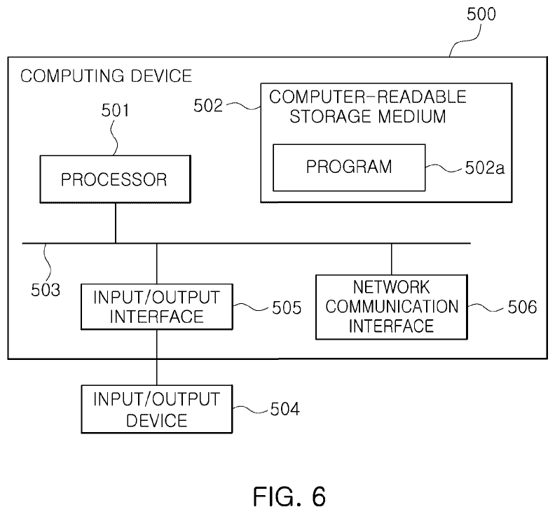

FIG. 6 is a block diagram illustrating a computing device 500 which may fully or partially implement a V2B charge/discharge scheduling device according to an embodiment of the present disclosure.

As illustrated in FIG. 6, a computing device 500 may include at least one processor 501, a computer-readable storage medium 502, and a communication bus 503, any combination of or all of which may be in plural or may include plural components thereof.

The processor 501 may cause the computing device 500 to operate according to the embodiment mentioned above. For example, the processor 501 may execute one or more programs stored in the computer-readable storage medium 502. The one or more programs may include one or more computer-executable commands, and when the computer-executable commands are executed by the processor 501, the computer-executable commands may be configured to cause the computing device 500 to perform operations according to an embodiment.

The computer-readable storage medium 502 may be configured to store computer-executable commands or program code, program data, and/or other suitable forms of information. The program 502a stored in the computer-readable storage medium 502 may include a group of commands executable by the processor 501. In an embodiment, the computer-readable storage medium 502 may be implemented as a memory (a volatile memory, such as a random access memory, a non-volatile memory, or an appropriate combination thereof), one or more magnetic disk storage devices, optical disk storage devices, flash memory devices, other types of storage media accessed by the computing device 500 and storing desired information, or a suitable combination thereof, for example.

The communication bus 503 may interconnect various other components of the computing device 500, including the processor 501 and the computer-readable storage medium 502.

The computing device 500 may also include one or more input/output interfaces 505 and one or more network communication interfaces 506 providing an interface for one or more input/output devices 504, any combination of or all of which may be in plural or may include plural components thereof. The input/output interface 505 and the network communication interface 506 may be connected to the communication bus 503. The input/output device 504 may be connected to other components of the computing device 500 through the input/output interface 505. The example input/output device 504 may include a pointing device (such as a mouse or trackpad), a keyboard, a touch input device (such as a touch pad or a touch screen), a voice or sound input device, various types of sensor devices, and/or an input device such as an imaging device, and/or an output device such as a display device, a printer, a speaker, and/or a network card. The example input/output device 504 may be included within the computing device 500 as a component included in the computing device 500, or may be connected to the computing device 500 as a device distinct from the computing device 500.

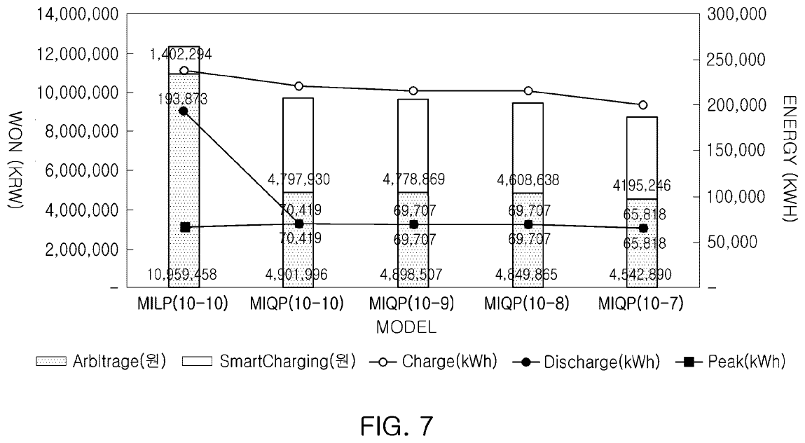

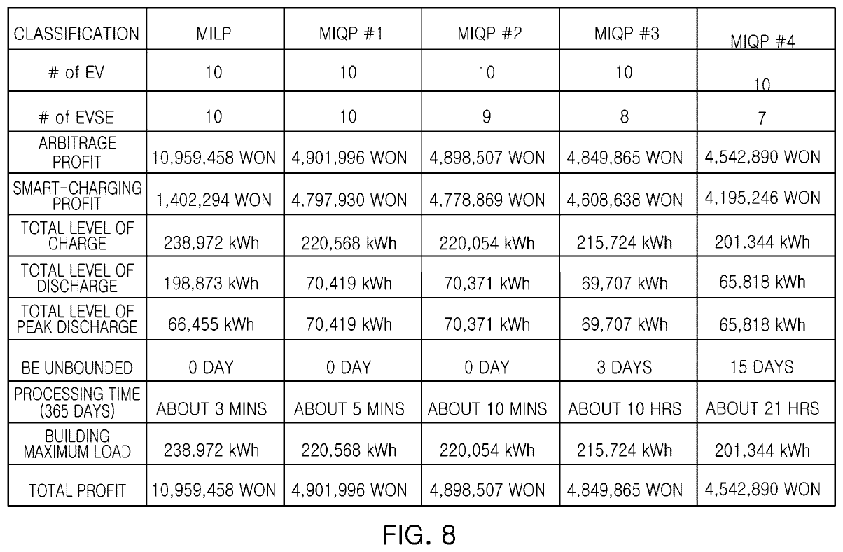

FIG. 7 is a graph indicating a profit effect according to an embodiment of the present disclosure. FIG. 8 is a table listing a profit effect according to an embodiment of the present disclosure.

Referring to FIGS. 7 and 8, in a MIQP model, when there is a shortage of EVSEs as compared to electric vehicles, a structure of matching electric vehicles to EVSEs may be reflected in the objective function, such that profitability to MILP may decrease. When the number of EVSEs decreases, complexity of the model may increase, such that the number of cases in which the optimal solution may not be found within one hour may also increase proportionally. However, the MIQP model may exhibit further improved performance than the MILP model in reducing a maximum load of the building.

For each model, a profit may be proportional to the number of EVSEs, and MILP, which does not require scheduling, exhibits the highest profit. In the example case of the MIQP model including scheduling, as illustrated in the profit results, the results exhibit that the plug-in time for electric vehicles and EVSEs may increase, such that, compared to the MILP model, smart-charging profit may increase, and arbitrage profit may decrease. This may be the result of not actively charging and discharging by adding the scheduling constraints and treating plug-in and plug-out as loss costs. However, the MIQP model may have an advantage over the MILP model in reducing maximum load through the Slackₚₑₐₖ formula. When the number of electric vehicles is greater than the number of EVSEs, using the MIQP model, the plug-in time of the electric vehicle and the EVSE may be maintained for a lengthy period of time, which may be advantageous in terms of practicality.

According to the aforementioned example embodiments, when the number of electric vehicles is not greater than the number of EVSEs, a scheduling model may be set to maximize the total profit due to a difference transaction profit, a smart-charging profit, and a total profit from preventing the building from exceeding contracted power.

Also, when the number of electric vehicles is greater than the number of EVSEs, the plug-in time of the electric vehicle and EVSE may be maintained for a lengthy period of time such that the scheduling complexity of the electric vehicle may be reduced, and a profit may be improved.

The advantages of the present disclosure are not limited to the above-described advantages, and a person skilled in the art can understand that other advantages not mentioned may be derived from an embodiment.

While the example embodiments have been illustrated and described above, it can be apparent to those skilled in the art that modifications and variations can be manufactured without departing from the scopes of the present disclosure as defined by the appended claims.

What is claimed is:

1. A vehicle to building (V2B) charge/discharge scheduling method comprising:
inputting input data including at least one of or any combination of electric vehicle information related to battery charging and discharging of electric vehicles, building information related to power use of a building, and electric vehicle supply equipment (EVSE) information related to EVSEs connected to the electric vehicles for charging and discharging a battery;
setting a scheduling model using the input data and an objective function;
outputting optimization data using the scheduling model; and
performing charge/discharge scheduling of the electric vehicles using the optimization data,
wherein the setting a scheduling model includes:
setting the scheduling model using mixed-integer linear programming (MILP) when a first count of the electric vehicles is not greater than a second count of the EVSEs; and
setting the scheduling model using mixed-integer quadratic programming (MIQP) when the first count of the electric vehicles is greater than the second count of the EVSEs.

2. The method of claim 1, wherein the electric vehicle information includes at least one of or any combination of an entry/exit plan of each of the electric vehicles, a state of charge of a battery at entry, a target state of charge at exit, a predetermined battery charging range, and a battery charge/discharge specification.

3. The method of claim 1, wherein the building information includes at least one of or any combination of a time-of-use price of electricity of a building, contract power of a building, and an estimated load of a building.

4. The method of claim 1, wherein the EVSE information includes plug-in/out information related to whether each of the EVSEs is connected to an electric vehicle.

5. The method of claim 4,
wherein if the first count of the electric vehicles is not greater than the second count of the EVSEs, the input data does not include the EVSE information, and
wherein if the first count of the electric vehicles is greater than the second count of the EVSEs, the input data includes the EVSE information.

6. The method of claim 1,
wherein if the first count of the electric vehicles is not greater than the second count of EVSEs, the objective function is configured as a linear objective function having a linear term, and
wherein if the first count of the electric vehicles is greater than the second count of the EVSEs, the objective function is configured as an objective function having a quadratic term.

7. The method of claim 6,
wherein the linear objective function includes a V2B cost function, and
wherein the V2B cost function includes discharge profit weight based on charging fee minus discharge profit minus building contract power being exceeded.

8. The method of claim 7,
wherein the objective function having a quadratic term includes the V2B cost function and a plug-in penalty function,
wherein the plug-in penalty function aims to maintain a plug-in state in which the EVSE and the electric vehicle are connected to each other.

9. A vehicle to building (V2B) charge/discharge scheduling method comprising:
inputting input data including at least one of or any combination of electric vehicle information related to battery charging and discharging of electric vehicles, building information related to power use of a building, and electric vehicle supply equipment (EVSE) information related to EVSEs connected to the electric vehicles for charging and discharging a battery;
setting a scheduling model using the input data and an objective function;
outputting optimization data using the scheduling model; and
performing charge/discharge scheduling of the electric vehicles using the optimization data.

10. The method of claim 9, wherein the setting a scheduling model comprises:
setting the scheduling model using mixed-integer linear programming (MILP) when a first count of the electric vehicles is not greater than a second count of the EVSEs; and
setting the scheduling model using mixed-integer quadratic programming (MIQP) when the first count of the electric vehicles is greater than the second count of the EVSEs.

11. The method of claim 9, wherein the electric vehicle information includes at least one of or any combination of an entry/exit plan of each of the electric vehicles, a state of charge of a battery at entry, a target state of charge at exit, a predetermined battery charging range, and a battery charge/discharge specification;
wherein the building information includes at least one of or any combination of a time-of-use price of electricity of a building, contract power of a building, and an estimated load of a building; and
wherein the EVSE information includes plug-in/out information related to whether each of the EVSEs is connected to an electric vehicle.

12. The method of claim 11, wherein if a first count of the electric vehicles is not greater than a second count of the EVSEs, the input data does not include the EVSE information;
wherein if the first count of the electric vehicles is greater than the second count of the EVSEs, the input data includes the EVSE information;
wherein if the first count of the electric vehicles is not greater than the second count of the EVSEs, the objective function is configured as a linear objective function having a linear term;
wherein if the first count of the electric vehicles is greater than the second count of the EVSEs, the objective function is configured as an objective function having a quadratic term;
wherein the linear objective function includes a V2B cost function, and wherein the V2B cost function includes discharge profit weight based on charging fee minus discharge profit minus building contract power being exceeded; and
wherein the objective function having a quadratic term includes the V2B cost function and a plug-in penalty function, wherein the plug-in penalty function aims to maintain a plug-in state in which the EVSE and the electric vehicle are connected to each other.

13. A vehicle to building (V2B) charge/discharge scheduling device comprising:
one or more processors; and
a storage medium storing computer-readable instructions that, when executed by the one or more processors, enable the one or more processors to:
input input data including at least one of electric vehicle information related to battery charging and discharging of electric vehicles, building information related to power use of a building, and electric vehicle supply equipment (EVSE) information related to EVSEs connected to the electric vehicles and charging and discharging a battery,
set a scheduling model using the input data and an objective function,
output optimization data using the scheduling model, and
perform charge/discharge scheduling of the electric vehicles using the optimization data,
wherein the setting of the scheduling model includes:
setting the scheduling model using mixed-integer linear programming (MILP) if a first count of the electric vehicles is not greater than a second count of the EVSEs, and
setting of the scheduling model using mixed-integer quadratic programming (MIQP) if the first count of the electric vehicles is greater than the second count of the EVSEs.

14. The device of claim 13, wherein the electric vehicle information includes at least one of or any combination of an entry/exit plan of each of the electric vehicles, a state of charge of a battery at entry, a target state of charge at exit, a predetermined battery charging range, and a battery charge/discharge specification.

15. The device of claim 13, wherein the building information includes at least one of or any combination of a time-of-use price of electricity of a building, contract power of a building, and an estimated load of a building.

16. The device of claim 13, wherein the EVSE information includes plug-in/out information related to whether each of the EVSEs is connected to an electric vehicle.

17. The device of claim 16,
wherein if the first count of the electric vehicles is not greater than the second count of the EVSEs, the input data does not include the EVSE information; and
wherein if the first count of the electric vehicles is greater than the second count of the EVSEs, the input data includes the EVSE information.

18. The device of claim 13,
wherein if the first count of the electric vehicles is not greater than the second count of the EVSEs, the objective function is configured as a linear objective function having a linear term; and
wherein if the first count of the electric vehicles is greater than the second count of the EVSEs, the objective function is configured as an objective function having a quadratic term.

19. The device of claim 18,
wherein the linear objective function includes a V2B cost function, and
wherein the V2B cost function includes discharge profit weight of charging fee minus discharge profit minus building contract power being exceeded.

20. The device of claim 18, wherein the objective function having a quadratic term includes the V2B cost function and a plug-in penalty function, and wherein the plug-in penalty function aims to maintain a plug-in state in which the EVSE and the electric vehicle are connected to each other.
